(19) United States
(12) Patent Application Publication
(10) Pub. No.: US 2006/0287863 A1
(43) Pub. Date: Dec. 21, 2006

(54) Speaker identification and voice verification for voice applications

(75) Inventors: Ricardo Dos Santos, Boca Raton, FL (US); Brien H. Muschett, Palm Beach Gardens, FL (US); Wendi L. Nusbickel, Boca Raton, FL (US)

Correspondence Address: CAREY, RODRIGUEZ, GREENBERG & PAUL, LLP;STEVEN M. GREENBERG, 900 PENINSULA CORPORATE CIRCLE, SUITE 3020, BOCA RATON, FL, 33487, US

(73) Assignee: International Business Machines Corporation, Armonk, NY (US)

(21) Appl. No.: 11/154,206

(22) Filed: Jun. 16, 2005

(51) Int. Cl. G10L 21/00

(52) U.S. Cl. 704/275

(57) ABSTRACT

Embodiments of the present invention address deficiencies of the art in respect to voice markup processing and provide a method, system and computer program product for speaker identification and voice verification in a voice processing system. In one embodiment, a speaker identification and voice verification data processing system can include a voice markup processor configured to process voice markup defining a voice application and server side logic enabled to be communicatively coupled to the voice markup processor and to a voice engine programmed for speaker identification and voice verification. For example, the voice engine can be programmed to provide speaker identification and voice verification using speaker identification verification (SIV) technology.

### BACKGROUND OF THE INVENTION

1. Field of the Invention

The present invention relates to the field of voice applications and more particularly to integrating speaker identification and voice verification logic in a voice application.

2. Description of the Related Art

Voice applications utilize voice processing to facilitate voice interactions with a data processing application. Voice markup processing represents one technology useful in voice processing and provides a flexible mode for handling voice interactions in a data processing application over a computer communications network. Specifically designed for deployment in the telephony environment, voice markup provides a standardized way for voice processing applications to be defined and deployed for interaction for voice callers over the public switched telephone network (PSTN). In recent years, the VoiceXML specification has become the predominant standardized mechanism for expressing voice applications.

Despite the popularity of VoiceXML and like markup languages for voice processing, speaker identification and voice verification have not been supported through conventional voice markup browsers. Speaker Identification Verification (SIV) is a speaker identification and voice verification technology used to identify a particular speaker in order to grant access to sensitive information and transactions. SIV introduces the concept of a “Voice Print”. Voice Prints are used for identification, similar to the way fingerprints identify people.

Typically, speaker identification involves two phases. In a first phase, referred to as enrollment, a user can create and associate a voice print with a speaker verification server. In a second phase, referred to as verification, speech collected from a speaker can be compared to the stored voice print to determine whether the speaker is whom the speaker professes to be. In a telephony environment, speaker verification can play an important rule in terms of adding an extra level of security before providing a caller access to sensitive data.

Though speaker identification and voice verification is a seemingly important aspect of data security, the failure of conventional voice processing systems to natively support speaker identification and voice verification has resulted in a hodge podge of ad hoc solutions and proprietary application programming interfaces. The proprietary nature of these ad hoc solutions has compromised compatibility across different voice processing systems and across different host computing environments.

### BRIEF SUMMARY OF THE INVENTION

Embodiments of the present invention address deficiencies of the art in respect to voice markup processing and provide a novel and non-obvious method, system and computer program product for speaker identification and voice verification in a voice processing system. In one embodiment, a speaker identification and voice verification data processing system can include a voice markup processor configured to process voice markup defining a voice application and server side logic enabled to be communicatively coupled to the voice markup processor and to a voice engine programmed for speaker identification and voice verification. For example, the voice engine can be programmed to provide speaker identification and voice verification using SIV technology.

The server side logic can be a servlet including code enabled both to receive postings from the voice markup processor requesting speaker identification and verification for encapsulated speech input, and also to return verification data to the voice markup processor based upon verification data received from the voice engine based upon the speech input. In one aspect of the invention, the encapsulated speech input can be encapsulated within a hypertext transfer protocol (HTTP) formatted request defined within the voice markup. In this regard, the voice markup can be obtained through a prompting of a speaker to receive the encapsulated speech input. Alternatively, the encapsulated speech input can be obtained through a saving of audio for a speech recognition operation defined within the voice markup.

A method for performing speaker identification and voice verification from a voice markup processing system can include processing voice markup to receive speech input for a speaker interacting with a voice application defined by the voice markup and posting a request to server side logic to verify the speaker using the speech input. The posting of the request to server side logic to verify the speaker using the speech input can include formatting an HTTP request for speaker identification and voice verification based upon the speech input and executing an HTTP post of the formatted HTTP request to the server side logic. A response can be received from the server side logic containing an indication of whether the speaker has been verified. In response, further access to the voice application can be permitted only if the speaker has been verified.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a voice markup processing system configured for speaker identification and voice verification; and,

FIG. 2 is a flow chart illustrating a process for performing speaker identification and voice verification in a voice markup driven voice application.

### DETAILED DESCRIPTION OF THE INVENTION

Embodiments of the present invention provide a method, system and computer program product for speaker identification and voice verification in a voice markup driven voice application. In accordance with an embodiment of the present invention, voice markup for the voice -markup driven voice application can be processed in a voice markup processor to acquire speech. The acquired speech can be posted to server side logic through an instruction in the voice markup for the voice markup driven voice application. The server side logic can process the acquired speech to perform speaker identification and voice verification. Finally, a result of the speaker identification and voice verification can be provided by the server side logic to the voice markup processor to permit a determination of whether to authorize continued interactions with the voice markup driven application.

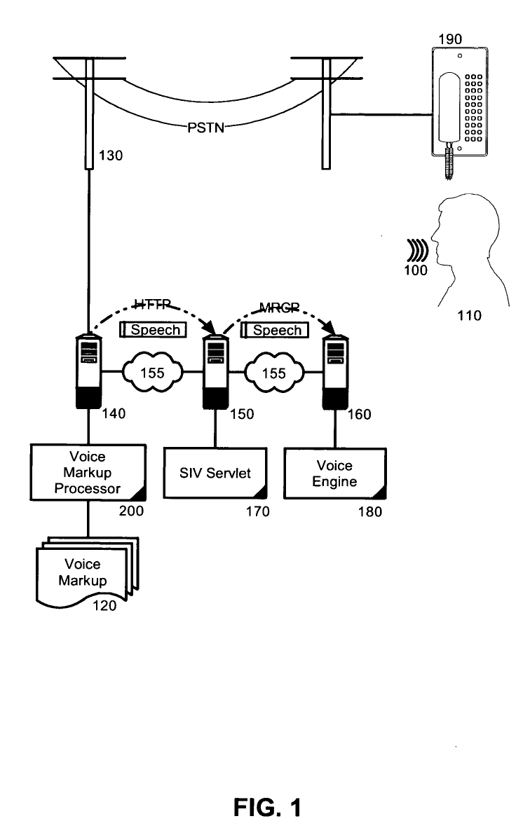

In further illustration, FIG. 1 is a schematic illustration of a voice markup processing system configured for speaker identification and voice verification. The voice markup processing system can include a voice markup processor 200 configured to process voice markup 120 defining a voice application. The voice markup processor 200 can be disposed in a voice gateway 140 coupled both to a data communications network 155 and to a public switched telephone network (PSTN) 130. In this way, speech 100 provided by a speaker 110 through a telephony device 190 over the PSTN 130 can be utilized as input to the voice application defined by the voice markup 120.

In accordance with the present invention, speech 100 acquired in the course of processing the voice markup 120 in the voice markup processor 200 can be posted to server side logic 170 disposed in an application server 150. The server side logic 170 can process conventional data postings in the hypertext transfer protocol (HTTP) and the acquired speech 100 can be extracted from the posting. Subsequently, the acquired speech 100 can be provided to a voice engine 180 in a host platform 160 in order to perform speaker identification and voice authentication. The voice engine 180 can implement SIV technology, as an example. The results from the speaker identification and voice authentication can be provided to the server side logic 170, which in turn, can provide the result to the voice markup processor 200 within an HTTP response.

As an example, the following is a portion of voice markup defining a posting of speech input to server side logic configured to process a request for speaker identification and voice verification:

<?xml version=“1.0” encoding=“UTF-8”?>
<vxml version=“2.0” xmlns=“http://www.w3.org/2001/vxml” xmlns:xsi=“
http://www.w3.org/2001/XMLSchema-instance” xsi:schemaLocation=“
http://www.w3.org/2001/vxml http://www.w3.org/TR/voicexml20/vxml.xsd”
xml:lang=“en-US”>
<var name=“claimant” expr=“claimant_identifier”/>
<form id=“SpeakerVerificationForm”>

<record name=“claimantVoice” beep=“true” maxtime=“10s”

finalsilence=“4000ms” dtmfterm=“true” type=“audio/x-wav”>
<prompt timeout=“5s”>

Please say your home address. Press any key when you are done.

</prompt>
<noinput>

I'm sorry, I didn't hear anything, please say your full home address.

</noinput>
<filled>

Please wait will we authenticate you.

</filled>

</record>
<subdialog name=“sivScores” src=“/sivresultEngine” method=“post”
enctype=“multipart/form-data” namelist=“claimant claimantVoice”/>

<param name=“claimid” expr=“claimant”/>
<filled>

<log label=“Siv Filled:Gender:” expr=“sivScores.result.gender”/>
<log label=“Siv Filled:Decision:” expr=“sivScores.result.decision”/>
<log label=“Siv Filled:Score:” expr=“sivScores.result.score”/>
<log label=“Siv Filled:ID:” expr=“sivScores.result.id”/>

</filled>
<catch event=“error.siv.claim.unknownclaimant”>

<log label=“Caught Event:”> Sorry No claimant on file </log>
<exit/>

</catch>

</subdialog>

</form>
</vxml>

In the exemplary markup, the acquired speech can be stored in association with the claimantVoice variable and provided to the server side logic entitled “sivScores” by posting a request containing not only the claimantVoice variable, but also the “claimant” parameter. It will be noted, however, that the speech can acquired in an alternative manner without requiring the processing of the “prompt” attribute. Rather, in another embodiment, the speech can be acquired through a speech recognition operation defined within the markup in which the acquired speech for the speech recognition operation can be saved as follows:

<?xml version=“1.0” encoding=“UTF-8”?>
<vxml version=“2.0” xmlns=“http://www.w3.org/2001/vxml” xmlns:xsi=“
http://www.w3.org/2001/XMLSchema-instance” xsi:schemaLocation=“
http://www.w3.org/2001/vxml http://www.w3.org/TR/voicexml20/vxml.xsd”
xml:lang=“en-US”>
<!-- asking the interpreter to save the audio used for speech recognition -->
<property name=“recordutterance” value=“true”/>
<var name=“claimant” expr=“claimant_identifier”/>
<form id=“sivEntry”>
<field name=“pin”>

<grammar src=“builtin:grammar/digits”/>

Please, say your 10 digit pin code
<noinput>

I'm sorry, I didn't hear anything, please say your pin code.

</noinput>
<catch event=“connection.disconnect.hangup”>

<exit/>

</catch>
<filled>

Please wait while we confirm your pin.

</filled>

</record>

</field>
<!-- submitting the saved audio to be verified -->
<subdialog name=“sivScores” src=“/sivresultEngine” method=“post” enctype=“multipart/form-data
” namelist=“claimant claimantVoice”/>

<param name=“claimid” expr=“claimant”/>
<filled>

<log label=“Siv Filled:Gender:” expr=“sivScores.result.gender”/>
<log label=“Siv Filled:Decision:” expr=“sivScores.result.decision”/>
<log label=“Siv Filled:Score:” expr=“sivScores.result.score”/>
<log label=“Siv Filled:ID:” expr=“sivScores.result.id”/>

</filled>
<catch event=“error.siv.claim.unknownclaimant”>

<log label=“Caught Event:”> Sorry No claimant on file </log>
<exit/>

</catch>

</subdialog>
</form>
</vxml>

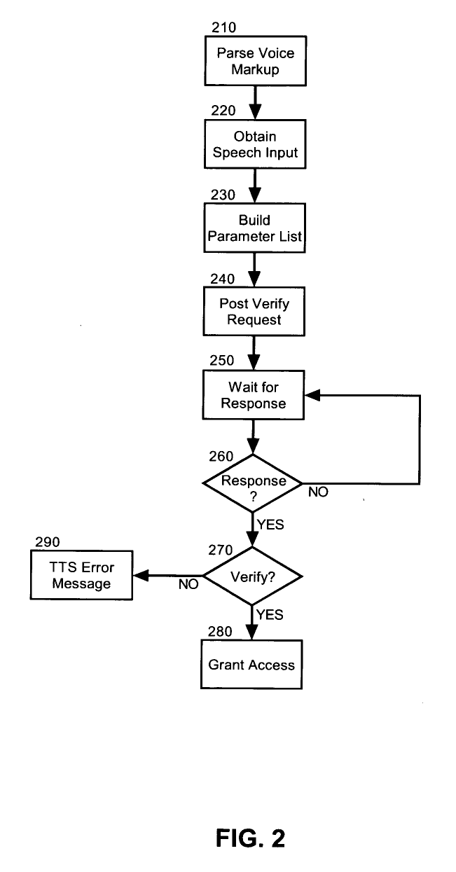

FIG. 2 is a flow chart illustrating a process for performing speaker identification and voice verification in a voice markup driven voice application. Beginning in block 210, voice markup defining a voice application can be parsed and processed. In block 220, speech input can be obtained in the course of processing the voice markup. For example, the speech input can be obtained as part of the speech recognition functionality of the voice markup, or the speech input can be obtained directly through a prompting defined within the voice markup.

Once the speech input has been obtained, in block 230 a parameter list can be constructed for the speech input. The parameter list can include an identifier for the speaker, for example. In consequence, a request can be constructed as instructed within the voice markup to include the speech input and the parameter list. Subsequently, in block 240 the request can be posted to server side logic so as to request speaker identification and verification of the speech input based upon the parameter list. In one aspect of the invention, the request can be an HTTP request and the server side logic can be a servlet operating in an application server.

Once the request has been posted to the server side logic, in block 250 a response can be awaited. In decision block 260, if a response is received, in decision block 270, it can be determined whether the response indicates that the speech input has been verified. If not, in block 290, an error message can be read back to the speaker. Otherwise, continue access to the voice application can be provided in block 280.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A speaker identification and voice verification (SIV) data processing system comprising:
a voice markup processor configured to process voice markup defining a voice application; and,
server side logic enabled to be communicatively coupled to said voice markup processor and to a voice engine programmed for speaker identification and voice verification.

2. The data processing system of claim 1, wherein said voice markup processor is a voice extensible markup language (VXML) processor.

3. The data processing system of claim 1, wherein said server side logic is a servlet comprising code enabled both to receive postings from said voice markup processor requesting speaker identification and voice verification for encapsulated speech input as specified in said voice markup, and also to return verification data to said voice markup processor based upon verification data received from said voice engine based upon said speech input.

4. The data processing system of claim 3, wherein said servlet is a Web service.

5. The data processing system of claim 3, wherein said encapsulated speech input is encapsulated within a hypertext transfer protocol (HTTP) formatted request defined within said voice markup.

6. The data processing system of claim 3, wherein said voice markup comprises a prompt to receive said encapsulated speech input.

7. The data processing system of claim 3, wherein said encapsulated speech input is saved audio for a speech recognition operation defined within said voice markup.

8. The data processing system of claim 1, wherein said voice engine is configured to utilize speaker identification verification (SIV) technology to perform said speaker identification and voice verification.

9. A method for performing speaker identification and voice verification from a voice markup processing system, the method comprising:
processing voice markup to receive speech input for a speaker interacting with a voice application defined by said voice markup;
posting a request to server side logic to verify said speaker using said speech input;
receiving a response from said server side logic containing an indication of whether said speaker has been verified; and,
permitting further access to said voice application only if said speaker has been verified.

10. The method of claim 9, wherein said processing voice markup to receive speech input for a speaker interacting with a voice application defined by said voice markup comprises processing voice extensible markup language (VoiceXML) to receive speech input for a speaker interacting with a voice application defined by said VoiceXML.

11. The method of claim 9, wherein said processing voice markup to receive speech input for a speaker interacting with a voice application defined by said voice markup comprises executing a prompt for said speaker to provide said speech input.

12. The method of claim 9, wherein said processing voice markup to receive speech input for a speaker interacting with a voice application defined by said voice markup comprises saving said speech input as part of executing a speech recognition function defined within said voice markup.

13. The method of claim 9, wherein said posting a request to server side logic to verify said speaker using said speech input comprises:
formatting a hypertext transfer protocol (HTTP) request for SIV based upon said speech input; and, executing an HTTP post of said formatted HTTP request to said server side logic.

14. A computer program product comprising a computer usable medium having computer usable program code for performing speaker identification and voice verification (SIV) from a voice markup processing system, said computer program product including:
computer usable program code for processing voice markup to receive speech input for a speaker interacting with a voice application defined by said voice markup;
computer usable program code for posting a request to server side logic to verify said speaker using said speech input;
computer usable program code for receiving a response from said server side logic containing an indication of whether said speaker has been verified; and, computer usable program code for permitting further access to said voice application only if said speaker has been verified.

15. The computer program product of claim 14, wherein said computer usable program code for processing voice markup to receive speech input for a speaker interacting with a voice application defined by said voice markup comprises computer usable program code for processing voice extensible markup language (VoiceXML) to receive speech input for a speaker interacting with a voice application defined by said VoiceXML.

16. The computer program product of claim 14, wherein said computer usable program code for processing voice markup to receive speech input for a speaker interacting with a voice application defined by said voice markup comprises computer usable program code for executing a prompt for said speaker to provide said speech input.

17. The computer program product of claim 14, wherein said computer usable program code for processing voice markup to receive speech input for a speaker interacting with a voice application defined by said voice markup comprises computer usable program code for saving said speech input as part of executing a speech recognition function defined within said voice markup.

18. The computer program product of claim 14, wherein said computer usable program code for posting a request to server side logic to verify said speaker using said speech input comprises:
computer usable program code for formatting a hypertext transfer protocol (HTTP) request for SIV based upon said speech input; and, computer usable program code for executing an HTTP post of said formatted HTTP request to said server side logic.
